(19) United States
(12) Patent Application Publication
(10) Pub. No.: US 2017/0085979 A1
(43) Pub. Date: Mar. 23, 2017

(54) Electroacoustic Transducer

(71) Applicant: Yamaha Corporation, Hamamatsu-shi, Shizuoka-ken (JP)

(72) Inventor: Masao NORO, Hamamatsu-shi, Shizuoka-ken (JP)

(21) Appl. No.: 15/310,522

(22) PCT Filed: May 14, 2015
(86) PCT No.: PCT/JP2015/063891

§ 371 Date: Nov. 11, 2016

(30) Foreign Application Priority Data
May 14, 2014 (JP) 2014-100112
Apr. 20, 2015 (JP) 2015-086309

(51) Int. Cl. H04R 1/24; H04R 7/26; H04R 9/06; H04R 9/02; H04R 7/12; H04R 7/18

(52) U.S. Cl. CPC H04R 1/24; H04R 7/127; H04R 7/18; H04R 9/06; H04R 9/025; H04R 7/26

(57) ABSTRACT

An electroacoustic transducer includes: a diaphragm including a cone portion having a conical shape such as a circular conical surface shape or an oval conical surface shape, and a wing-pair portion having a pair of longitudinal split tubular surfaces arranged next to each other, a valley being formed between a side portion of one of the longitudinal split tubular surfaces and a side portion of the other of the longitudinal split tubular surfaces; a converter that performs conversion between vibration of the diaphragm along an axis of the cone portion and an electric signal corresponding to the vibration; and a supporter that supports the diaphragm such that the diaphragm is movable in an axial direction of the cone portion. The small-diameter-side end portion of the cone portion, and a bottom portion of a valley of the wing-pair portion are secured to the converter.

### TECHNICAL FIELD

The present invention relates to an electroacoustic transducer for a speaker configured to reproduce sounds by vibrating a diaphragm and to a microphone configured to pick up sounds.

### BACKGROUND ART

Typical dynamic speakers include: a diaphragm having a circular conical surface shape, called a cone; and a voice coil motor which causes piston motion for reciprocating the diaphragm to produce sounds. The typical dynamic speakers function substantially as a point sound source and exhibit a wide directivity at low frequencies but exhibit a sharp directivity over a frequency range equal to or higher than a frequency at which the diameter of a bore of the diaphragm is substantially equal to a half-wavelength of the reproduced sounds. Thus, small speakers using a diaphragm having small bores are used to reproduce sounds at high frequencies.

This also applies to dynamic microphones whose operation principle is reverse to that of the dynamic speakers. That is, small microphones using a diaphragm having a small bore are used to pick up high frequencies with a wide directivity.

In riffell speakers, in contrast, a diaphragm is constituted by a pair of rectangular curved plates, and the directivity is wide at middle and high frequencies. Also, sounds produced by the riffell speaker are radiated in a lateral direction along a direction of curve of the diaphragm and hardly radiated in a vertical direction.

Patent Documents 1 and 2 disclose conventional riffell speakers.

Patent Document 1 discloses a speaker in which a conductor pattern as a voice coil is printed on a central portion of a polymeric resin film, and the central portion is folded and bonded to form a diaphragm which includes first and second curved vibration portions and a planar plate portion having the conductor pattern, the planar plate portion and first and second curved vibration portions being formed integrally with each other. The planar plate portion of the diaphragm is disposed in a magnetic gap formed in a magnetic circuit, and distal edges of the first and second curved vibration portions are secured to a supporter.

Patent Document 2 discloses a speaker in which a central portion of a diaphragm is folded so as to form a recessed portion in which a flat voice coil wound in an oval annular shape is disposed in two magnetic gaps that are spaced apart from each other in an up and down direction. Also in this speaker, an outer peripheral portion of the diaphragm is secured to an annular frame.

### PRIOR ART DOCUMENTS

### Patent Documents

Patent Document 1: Japanese Patent Application Publication No. 2002-78079

Patent Document 2: Japanese Patent Application Publication No. 2007-174233

Patent Document 3: Japanese Patent Application Publication No. 8-140175

### SUMMARY OF THE INVENTION

### Problem to be Solved by the Invention

However, the riffell speaker of this type is not appropriate for reproducing sounds at low frequencies. The riffell speaker needs to be additionally configured as a multi-speaker system using a speaker for low frequencies (i.e., a woofer) to reproduce sounds over the full range of audible frequencies.

As one example of another type of speaker, Patent Document 3 discloses a double-cone speaker including a main cone for a dynamic speaker and a smaller-diameter sub-cone provided coaxially in front of the main cone, in order to reproduce sounds over a wide frequency range. However, this speaker has not been improved enough to act as an alternative to multi-speaker systems.

This invention has been developed in view of the above-described situations, and it is an object of the present invention to provide an electroacoustic transducer using one speaker unit for exhibiting a wide directivity over a wide frequency range extending from low frequencies to high frequencies.

### Means for Solving Problem

The inventor of the present invention has analyzed an operation principle of a speaker having a pair of curved vibration surfaces like riffell speakers and found that the width of directivity depends not on a feature in which an area of vibration over a high frequency range centers on a line sound source but on a shape of a diaphragm itself. Thus, the inventor has concluded that combination of the diaphragm having this shape and a cone portion for the low frequency range enables achievement of a speaker unit capable of reproducing sounds over a frequency range from low frequencies to high frequencies. The following is means for solving the problem.

An electroacoustic transducer according to the present invention includes: a diaphragm including a cone portion having a conical shape, and a wing-pair portion having a pair of longitudinal split tubular surfaces arranged next to each other, a valley being formed between a side portion of one of the longitudinal split tubular surfaces and a side portion of the other of the longitudinal split tubular surfaces; a converter that performs conversion between vibration of the diaphragm along an axis of the cone portion and an electric signal corresponding to the vibration; and a supporter that supports the diaphragm such that the diaphragm is movable in an axial direction of the cone portion. The small-diameter-side end portion of the cone portion, and a part of a portion of the wing-pair portion which portion defines the valley are secured to the converter.

This electroacoustic transducer is configured such that the diaphragm includes the cone portion and the wing-pair portion having the longitudinal split tubular surfaces. Thus, in the case where the present invention is applied to the speaker, the wing-pair portion is vibrated to reproduce sounds having a wide directivity at middle and high frequencies as in the riffell speakers, and the cone portion is vibrated to reproduce sounds having a high sound pressure over the low frequency range as in the dynamic speakers.

This construction enables a single speaker unit to function as a full-range speaker unit capable of reproducing sounds having a wide directivity over the full range of audible frequencies including low frequencies and middle and high frequencies.

Also in the case where the present invention is applied to the microphones, the longitudinal split tubular surfaces are vibrated to pick up sounds at middle and high frequencies, and the cone portion is vibrated to pick up sounds over the low frequency range, enabling the microphones to pick up sounds having a wide directivity over a frequency range from the low frequency range to middle and high frequencies.

The electroacoustic transducer is preferably configured such that the converter includes: a magnet mechanism secured to the supporter; and a coil that is vibrated in the axial direction with respect to the magnet mechanism, that the part of the portion of the wing-pair portion which portion defines the valley is a bottom portion that defines a bottom of the valley, and that the bottom portion of the wing-pair portion is secured to the coil.

The electroacoustic transducer is preferably configured such that the converter includes: a magnet mechanism secured to the supporter; and a coil that is vibrated in the axial direction with respect to the magnet mechanism, that the part of the portion of the wing-pair portion which portion defines the valley is the pair of longitudinal split tubular surfaces, and that back surfaces of the pair of longitudinal split tubular surfaces are secured to the coil.

The electroacoustic transducer is preferably configured such that the back surfaces of the pair of longitudinal split tubular surfaces are secured to one of opposite end portions of the coil in the axial direction, which one is nearer to the wing-pair portion than the other.

The electroacoustic transducer is preferably configured such that the converter includes: a magnet mechanism secured to the supporter; and a coil that is vibrated in the axial direction with respect to the magnet mechanism, and that the small-diameter-side end portion of the cone portion is secured to the coil.

The electroacoustic transducer is preferably configured such that the small-diameter-side end portion of the cone portion is secured to a peripheral portion of the coil.

The electroacoustic transducer according to the present invention preferably further includes a low-pass filter mechanism that reduces the vibration transmitted from the converter to the cone portion.

The low-pass filter mechanism reduces vibration of the cone portion over the high frequency range, preventing the cone portion from interfering with reproduction or pick-up of sounds over the high frequency range by the wing-pair portion.

The electroacoustic transducer is preferably configured such that the low-pass filter mechanism is provided on the cone portion.

The electroacoustic transducer according to the present invention is preferably configured such that the low-pass filter mechanism is configured by making a modulus of elasticity of the small-diameter-side end portion of the cone portion less than that of the wing-pair portion.

As the configuration for reducing the modulus of elasticity of the small-diameter-side end portion of the cone portion, an opening may be formed in the small-diameter-side end portion of the cone portion.

The opening reduces the stiffness of the small-diameter-side end portion of the cone portion, resulting in smaller modulus of elasticity. The number, the size, the shape, the arrangement, and other parameter of the opening may be set as needed to adjust a cutoff frequency as a mechanical low-pass filter, enabling achievement of the electroacoustic transducer with desired sound quality.

In the case where the opening is formed in the small-diameter-side end portion of the cone portion, a damper that damps vibration of the small-diameter-side end portion may be provided for the opening.

Components such as a resin film and a rubber film may be used as the damper. Selection of its material and the like can adjusts a Q value as the mechanical low-pass filter, enabling achievement of the electroacoustic transducer with desired sound quality.

The electroacoustic transducer according to the present invention is preferably configured such that a plurality of openings are formed each as the opening, and that the bottom portion of the wing-pair portion is inserted in two openings of the plurality of openings.

The electroacoustic transducer according to the present invention is preferably configured such that the damper is provided for at least one opening of the plurality of openings which is different from the two openings.

### Effects of the Invention

In the case where the electroacoustic transducer according to the present invention is applied to a speaker, this speaker provides a higher sound pressure at low frequencies by the cone portion and has wide directivity at middle and high frequencies due to radiation of reproduced sounds from the longitudinal split tubular surfaces. As a result, a full-range speaker unit having a wide directivity over a wide range extending from low frequencies to middle and high frequencies can be achieved by a single speaker unit. Also in the case where the electroacoustic transducer according to the present invention is applied to microphones, this microphone can pick up sounds with a wide directivity over a frequency range extending from low frequencies to high frequencies.

### BRIEF DESCRIPTION OF THE DRAWINGS

FIG. 1 is an exploded perspective view of a speaker according to a first embodiment of the present invention.

FIG. 2 is a perspective view of the speaker in its assembled state.

FIG. 3 is a front elevational view of the speaker in FIG. 2.

FIG. 4 is a cross-sectional view taken along line A-A in FIG. 3.

FIG. 5 is a perspective view of a half part of the speaker in FIG. 2, illustrating its cross section.

FIG. 6 is an enlarged exploded perspective view of a diaphragm used in the speaker according to the first embodiment.

FIG. 7 is a perspective view of the diaphragm in FIG. 6 in its assembled state.

FIG. 8 is an exploded perspective view of a speaker according to the second embodiment of the present invention.

FIG. 9 is a perspective view of the speaker illustrated in FIG. 8 in its assembled state.

FIG. 10 is a cross-sectional view of the speaker in FIG. 8.

FIG. 11 is a cross-sectional view of a speaker according to a third embodiment of the present invention.

### EMBODIMENTS

Hereinafter, there will be described, with reference to drawings, embodiments in which electric acoustic devices according to the present invention are applied to speakers.

### 1. Overall Construction

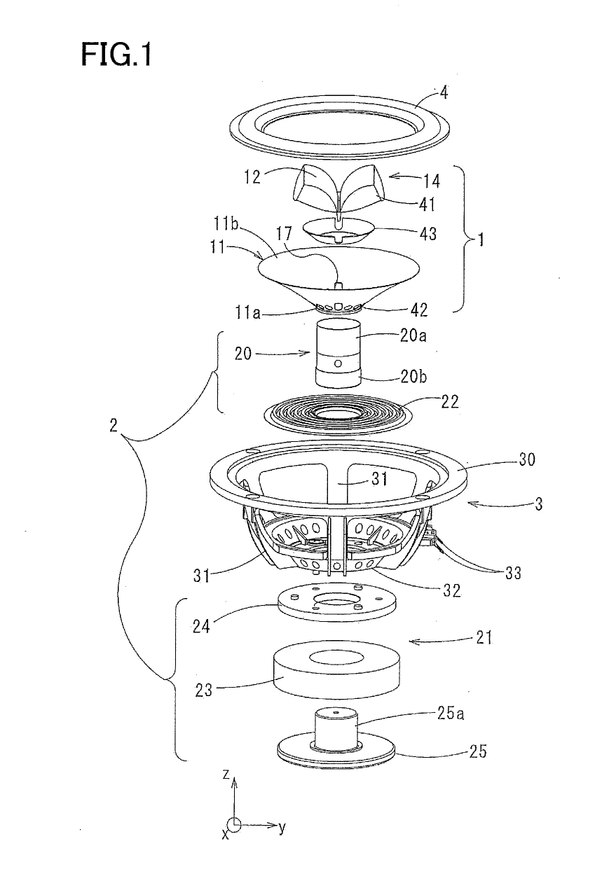

FIGS. 1-7 illustrate a speaker (an electric acoustic device) 100 according to a first embodiment of the present invention.

The speaker 100 according to this embodiment includes: a diaphragm 1; an actuator 2 (as one example of a converter) for causing reciprocation of the diaphragm 1; a support frame 3 for supporting the diaphragm 1 and the actuator 2; and an edge member 4 for supporting the diaphragm 1 such that the diaphragm 1 is reciprocable relative to the support frame 3.

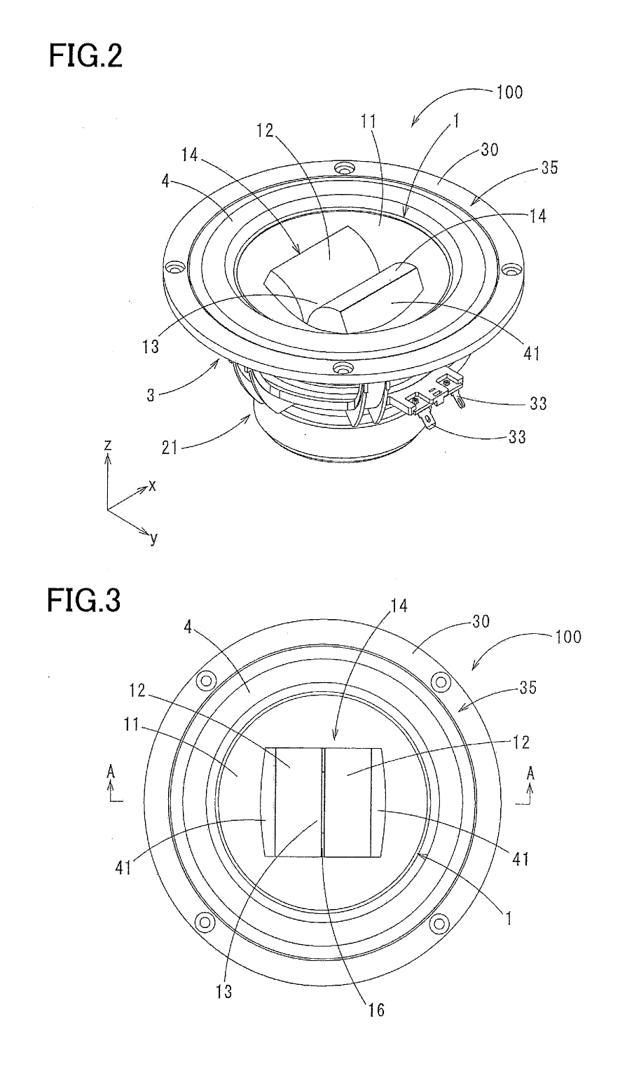

In the state illustrated in FIG. 2, the up and down direction is defined such that the upper side is a side on which the edge member 4 is provided, and the lower side is a side on which the actuator 2 is provided. The direction which is perpendicular to the up and down direction and in which a valley 13 of the diaphragm 1, which will be described below, extends is defined as the x direction. The direction perpendicular to this x direction is defined as the y direction. The up and down direction may be hereinafter referred to as the z direction with respect to the x direction and the y direction. Surfaces facing upward may be referred to as front surfaces, and surfaces facing downward as back surfaces.

### 2. Constructions of Components

### (1) Construction of Diaphragm

As illustrated in FIGS. 2 and 3, for example, the diaphragm 1 includes: a cone portion 11 having a circular conical surface shape; a wing-pair portion 14 provided on a front side of a central portion of the cone portion 11. The wing-pair portion 14 has a rectangular shape in front view.

The wing-pair portion 14 includes: a pair of longitudinal split tubular surfaces 12 arranged side by side; and the valley 13 defined between side portions of the respective longitudinal split tubular surfaces 12.

It is noted that each of the longitudinal split tubular surfaces 12 is shaped by cutting a portion of a surface of a tube in its longitudinal direction. The above-described side portions of the longitudinal split tubular surfaces 12 are side portions in a direction in which the tubular surfaces are curved.

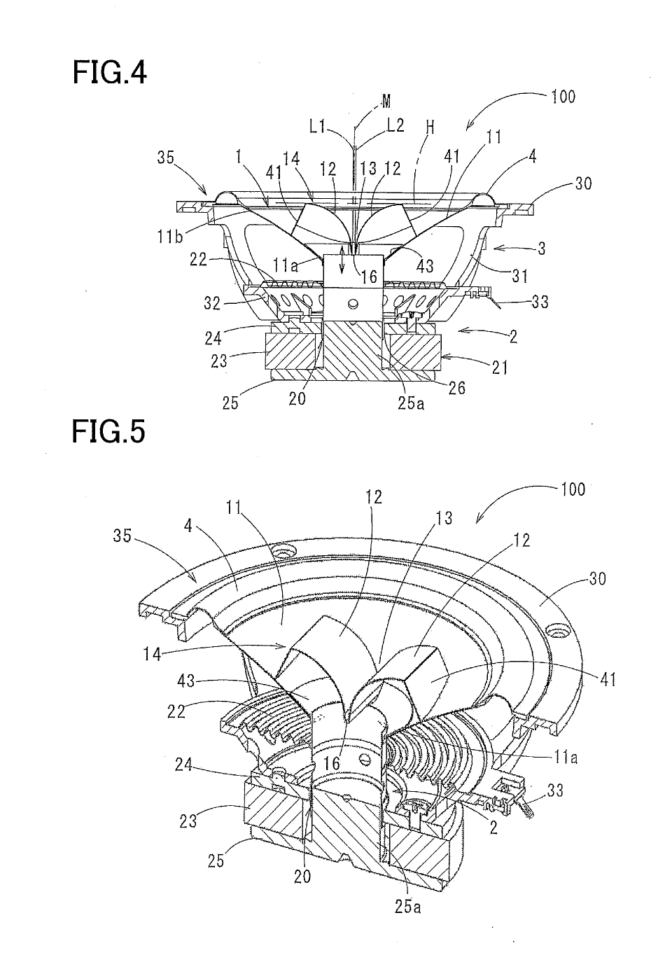

Each of the longitudinal split tubular surfaces 12 is curved in one direction (the widthwise direction coinciding with the circumferential direction of the longitudinal split tubular surface 12). The longitudinal split tubular surface 12 extends straight in a direction perpendicular to the one direction (the longitudinal direction of the longitudinal split tubular surfaces 12). That is, the longitudinal split tubular surface 12 is not curved in the direction perpendicular to the one direction. The pair of longitudinal split tubular surfaces 12 are arranged side by side so as to each protrude in its front surface direction. The adjacent side portions are arranged and joined to each other so as to be substantially parallel with a direction tangent to the longitudinal split tubular surfaces 12 at a bottom portion 16 of the valley 13 in cross section along the circumferential direction of the longitudinal split tubular surface 12. As illustrated in FIG. 4, the longitudinal split tubular surfaces 12 are joined so as to be slightly spaced apart from each other at the bottom portion 16 of the valley 13. Thus, the tangents L1, L2 at the bottom portion 16 of the valley 13 are parallel with each other. It is noted that the valley 13 is defined by some components of the wing-pair portion 14 (which include the pair of longitudinal split tubular surfaces 12, the bottom portion 16, and end plates 18 which will be described below).

It is noted that the cross-sectional shape of the longitudinal split tubular surface 12 may not be a single arc and may have a continuous series of curvatures. The wing-pair portion 14 may be constructed such that a cross section thereof along the circumferential direction (the widthwise direction) of the longitudinal split tubular surface 12 has a curvature that changes constantly or continuously like a parabola and a spline curve. Also, the wing-pair portion 14 may be constructed such that each of the longitudinal split tubular surfaces 12 is shaped like a surface of a polygonal tube. Also, the diaphragm 1 may be constructed such that the wing-pair portion 14 may be stepped so as to have a plurality of steps, for example.

To achieve uniform acoustic characteristics (frequency characteristics and directivity), the longitudinal split tubular surfaces 12 are preferably symmetric with respect to a plane M parallel with the valley 13 and located at a midpoint between the tangents L1, L2 at the bottom portion 16 of the valley 13. It is noted that the longitudinal split tubular surfaces 12 may not be symmetric in the present invention.

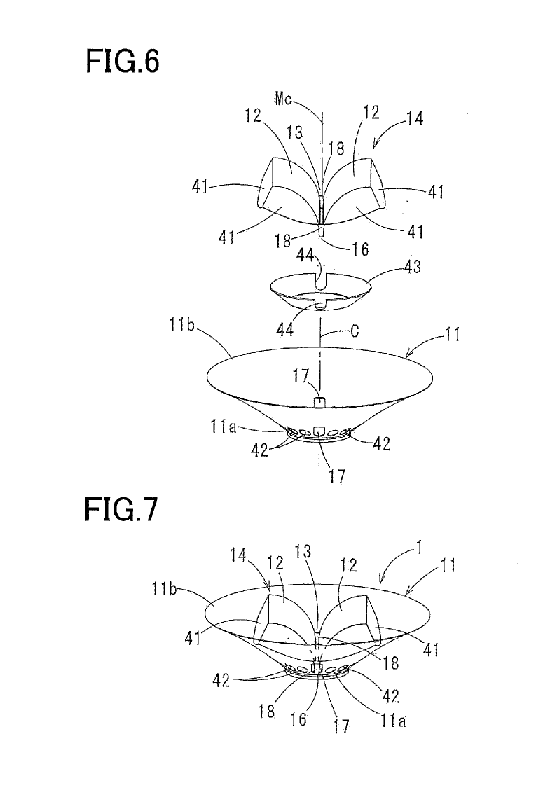

A center line on the plane M in the longitudinal direction of the valley 13 of the wing-pair portion 14 is defined as a central axis Mc of the wing-pair portion 14 (see FIG. 6).

As illustrated in FIGS. 6 and 7, the wing-pair portion 14 is placed on a small-diameter-side end portion 11a of the cone portion 11 having the circular conical surface shape, such that the valley 13 points downward. The wing-pair portion 14 is fixed to the small-diameter-side end portion 11a in a state in which the central axis Mc of the wing-pair portion 14 coincides with the central axis C of the cone portion 11 (see FIG. 6) and such that the bottom portion 16 of the valley 13 of the wing-pair portion 14 extends along the radial direction of the small-diameter-side end portion 11a of the cone portion 11 at a lower end portion of the diaphragm 1.

As illustrated in FIGS. 6 and 7, the small-diameter-side end portion 11a of the cone portion 11 has cutouts 17 (each as one example of an opening) for respectively holding opposite end portions of the bottom portion 16 of the valley 13 of the wing-pair portion 14. The opposite end portions of the bottom portion 16 of the valley 13 are fitted in the respective cutouts 17, and in this state the bottom portion 16 is bonded and fixed to the small-diameter-side end portion 11a of the cone portion 11, for example. The end plates 18 are respectively provided at opposite ends of the bottom portion 16 of the valley 13 so as to close the valley 13. With this construction, when the opposite end portions of the bottom portion 16 of the valley 13 of the wing-pair portion 14 are fitted in the respective cutouts 17 formed in the cone portion 11, the valley 13 is not open to a back-surface side of the cone portion 11. This state prevents sound waves from passing between a front-surface side and the back-surface side of the cone portion 11, enabling efficient radiation of sound waves from the entire front surface of the wing-pair portion 14.

Support members 41 each shaped like a thin film are provided on side portions of the wing-pair portion 14 in the widthwise direction and the longitudinal direction of the longitudinal split tubular surfaces 12 except opposite end portions of the valley 13 on which the respective end plates 18 are provided. In this state, the support member 41 closes spaces between the cone portion 11 and the longitudinal split tubular surfaces 12. The support members 41 support the wing-pair portion 14 such that the wing-pair portion 14 is reciprocable. The support members 41 define a space such that sound waves radiated from the wing-pair portion 14 do not travel to a back-surface side of the wing-pair portion 14. Each of the support members 41 is formed of a soft material like the edge member 4 so as to prevent hindrance to vibrations of the cone portion 11 and the wing-pair portion 14. Each of the support members 41 may be formed of a foamed material having the thickness of about 1-2 mm, for example.

A plurality of round openings 42 (each as another example of the opening) are formed through the small-diameter-side end portion 11a of the cone portion 11 at an area supporting the wing-pair portion 14 and surrounded by the support members 41. A damper 43 is attached to the cone portion 11 to close these openings 42. The damper 43 is constituted by a thin film such as a resin film and a rubber film. These openings 42 are spaced apart from each other in the circumferential direction of the small-diameter-side end portion 11a of the cone portion 11 at a particular distance. The damper 43 is shaped like a strip and attached to the cone portion 11 along the circumferential direction of the small-diameter-side end portion 11a. It is noted that the damper 43 has grooves 44 in which the bottom portion 16 of the valley 13 of the wing-pair portion 14 is fitted. That is, the damper 43 is attached to the cone portion 11 so as not to close the cutouts 17.

It is noted that each of the openings 42 may not be a round opening and may be an opening with other shapes such as an oval hole, a long, narrow hole, and a helical opening. A single opening may be defined as the openings 42. The openings 42 may be replaced by a thin portion or a bellows-shape portion. The damper 43 need not close all the openings 42 formed in the small-diameter-side end portion 11a and may close at least one of the openings 42. The damper 43 need not close the entire portion of the single opening 42 and may close a portion of the opening.

The cone portion 11 and the wing-pair portion 14 of the diaphragm 1 may be formed of any material such as synthetic resin, paper, and metal which are typically used for diaphragms of speakers. For example, the diaphragm 1 can be formed relatively easily by vacuum forming of a film formed of synthetic resin such as polypropylene and polyester.

In the diaphragm 1 in this embodiment, the cone portion 11 is formed of typical cone paper. The wing-pair portion 14 is formed as one piece by vacuum molding of a single film formed of synthetic resin. The bottom portion 16 of the valley 13 of the wing-pair portion 14 is formed by folding a central portion of the film in a U-shape in cross section. The openings 42 are formed in the cone portion 11 as described above, whereby the modulus of elasticity of the small-diameter-side end portion 11a of the cone portion 11 is less than that of the other portion of the cone portion 11. The damper 43 as a thin film may also be formed of any material but is formed of materials having a mechanical resistance that is greater than that of the cone paper forming the cone portion 11.

The diaphragm 1 constructed as described above includes two vibration surfaces (sound emitting surfaces) different from each other in shape, that is, the diaphragm 1 includes the vibration surfaces of the wing-pair portion 14 and the cone portion 11. As illustrated in FIGS. 2 and 7, the wing-pair portion 14 is constructed such that the entire longitudinal split tubular surfaces 12 as the vibration surfaces face frontward (in the z direction as the up direction). In contrast, the cone portion 11 is constructed such that the wing-pair portion 14 is disposed on the small-diameter-side end portion 11a. A front surface of an exposed upper portion of the cone portion 11 on which the wing-pair portion 14 is not disposed serves as the vibration surface (the sound emitting surface) that faces frontward (in the z direction as the up direction).

### (2) Construction of Components other than Diaphragm

The actuator 2 includes a voice coil 20 and a magnet mechanism 21 fixed to the support frame 3. A voice coil motor is used for the voice coil 20, for example. The voice coil 20 is provided on the bottom portion 16 of the valley 13 of the wing-pair portion 14 and the small-diameter-side end portion 11a of the cone portion 11 of the diaphragm 1.

The voice coil 20 includes a bobbin 20a having a cylindrical shape and a coil 20b wound around the bobbin 20a. An upper end of the voice coil 20 is fixed to a lower end of the diaphragm 1 (a lower end portion of the cone portion 11 and a lower end portion of the wing-pair portion 14) with an adhesive, for example, such that the axial direction of the voice coil 20 coincides with the axial direction of the cone portion 11 of the diaphragm 1 and such that the bottom portion 16 of the valley 13 of the wing-pair portion 14 is disposed along the diameter direction of the voice coil 20. In this state, as illustrated in FIGS. 4 and 5, an upper end portion of the voice coil 20 is inserted from the small-diameter-side end portion 11a of the cone portion 11, and an inserted end of the upper end portion of the voice coil 20 is in contact with the bottom portion 16 of the valley 13 of the wing-pair portion 14. As a result, both of the small-diameter-side end portion 11a of the cone portion 11 and the bottom portion 16 of the valley 13 of the wing-pair portion 14 are fixed to the upper end portion of the voice coil 20.

An outer circumferential portion of the voice coil 20 is supported by the support frame 3, with a damper 22 disposed therebetween. The voice coil 20 is reciprocable with respect to the support frame 3 in the axial direction of the voice coil 20. The damper 22 may be formed of a material which is used for the typical dynamic speaker.

The magnet mechanism 21 includes an annular magnet 23, a ring-shaped outer yoke 24 secured to one of opposite poles of the magnet 23, and an inner yoke 25 secured to the other of the opposite poles of the magnet 23. A distal end portion of a pole 25a standing on a center of the inner yoke 25 is disposed in the outer yoke 24, whereby an annular magnetic gap 26 is formed between the outer yoke 24 and the inner yoke 25, and an end portion of the voice coil 20 is disposed in the magnetic gap 26.

The support frame 3 is formed of metal, for example. In the illustrated example, the support frame 3 includes: a flange portion 30 shaped like a rectangular frame; a plurality of arm portions 31 extending downward from the flange portion 30; and an annular frame portion 32 formed on lower ends of the respective arm portions 31. An inner circumferential surface of the flange portion 30 has an annular shape. The diaphragm 1 is disposed in the inner circumferential surface of the flange portion 30 in a state in which the small-diameter-side end portion 11a of the cone portion 11 and the bottom portion 16 of the valley 13 of the wing-pair portion 14 face downward. A large-diameter-side end portion lib of the cone portion 11 of the diaphragm 1 is supported by an upper surface of the flange portion 30, with the edge member 4 interposed therebetween. Thus, the edge member 4 has a round ring shape corresponding to the shape of the cone portion 11 of the diaphragm 1. This edge member 4 can be formed of a material which is used for the typical dynamic speaker.

A supporter 35 that supports the diaphragm 1 so as to allow its vibration in the axial direction of the cone portion 11 (in the z direction as the depth direction of the valley 13) in the present invention is constituted by the support frame 3 and the edge member 4 in the present embodiment.

As illustrated in FIG. 4, in a state in which the diaphragm 1 is mounted on the support frame 3, in the case where a boundary line H is a line connecting between outermost ends of the respective longitudinal split tubular surfaces 12 in their respective curving directions (in the illustrated example, a line connecting between portions of the respective longitudinal split tubular surfaces 12 which are connected to the respective support members 41 on an opposite sides thereof from the bottom portion 16 of the valley 13), each of the longitudinal split tubular surfaces 12 is curved in such a direction that a distance between the longitudinal split tubular surface 12 and the boundary line H increases with increase in distance from the distal end of the longitudinal split tubular surface 12 toward the valley 13.

As described above, the longitudinal split tubular surface 12 is not limited to a single arc surface and may be a surface whose cross section has a continuous series of curvatures, a surface whose cross section has a curvature which changes continuously or constantly like a parabola and a spline curve, a surface shaped like a surface of a polygonal tube, and a surface having a plurality of step portions, but the longitudinal split tubular surfaces 12 are preferably shaped so as not to project from the boundary line H connecting between the distal ends of the respective longitudinal split tubular surfaces 12.

It is noted that the reference numeral 33 in, e.g., FIGS. 1 and 2 denotes a terminal for connecting the voice coil 20 to external devices.

### 3. Operations

In the speaker 100 constructed as described above, when a drive current based on a voice signal is supplied to the voice coil 20 of the actuator 2 secured to the diaphragm 1, a driving force generated based on the drive current is applied to the voice coil 20 by a change in magnetic flux generated by the drive current and a magnetic field in the magnetic gap 26, and the voice coil 20 is vibrated in a direction perpendicular to the magnetic field (i.e., the axial direction of the voice coil 20 or the up and down direction indicated by the arrows in FIG. 4). This vibration causes the diaphragm 1 connected to the voice coil 20 to be vibrated along the axial direction of the cone portion 11 (the depth direction of the valley 13) to radiate reproduced sounds from the front surface of the diaphragm 1.

The diaphragm 1 includes the wing-pair portion 14 and the cone portion 11, both of which have the respective vibration surfaces. As described above, the wing-pair portion 14 is constructed such that reproduced sounds are radiated from the longitudinal split tubular surfaces 12. Thus, like diaphragms used for riffell speakers, the directivity of sounds reproduced by the wing-pair portion 14 is wide at middle and high frequencies. In contrast, since the cone portion 11 reproduces sounds using piston motion of its conical front surface, the cone portion 11 has a wide directivity at low frequencies.

The small-diameter-side end portion 11a of the cone portion 11 has the openings 42, resulting in the lower modulus of elasticity in the area in which the openings 42 are formed. Thus, in the case where the frequency of vibration of the voice coil 20 of the actuator 2 is low, the entire cone portion 11 is vibrated together with the voice coil 20, but in the case of high frequencies, the portion of the small-diameter-side end portion 11a in which the openings 42 are formed reduces transmission of the vibration to an upper portion of the cone portion 11. This reduces the vibration of the upper portion of the cone portion 11. That is, the openings 42 formed in the small-diameter-side end portion 11a of the cone portion 11 constitutes a filter mechanism serving as a low-pass filter for vibration to be transmitted between the vibration surface of the upper portion of the cone portion 11 and the voice coil 20 of the actuator 2. This construction prevents the cone portion 11 from interfering with sound reproduction of the wing-pair portion 14 over a high frequency range.

This construction of the speaker enables a single speaker unit to function as a full-range speaker unit capable of reproducing sounds having a wide directivity over the full range of audible frequencies including low frequencies and middle and high frequencies.

In this case, the number, the size, the shape, the arrangement, and other parameter of the openings 42 can be set as needed to set a cutoff frequency as a mechanical low-pass filter. Since the damper 43 is attached to the openings 42, the material, the thickness, and other parameters of the damper 43 can be selected as needed to set a Q value (Quality factor) of a resonance as a mechanical low-pass filter. Thus, the constructions of the openings 42 and the damper 43 enable optimum setting of frequency characteristics of the mechanical low-pass filter, resulting in an electroacoustic transducer with desired acoustic characteristics. Accordingly, it is possible to consider that the low-pass filter mechanism is constituted by the openings 42 and the damper 43.

The wing-pair portion 14 is constructed such that the support members 41 respectively supporting the edges of the respective longitudinal split tubular surfaces 12 on the cone portion 11 are arranged so as to surround the edges of the respective longitudinal split tubular surfaces 12. Also, the end plates 18 respectively close the opposite ends of the bottom portion 16 of the valley 13. This construction prevents sounds waves radiated from the front surface of the wing-pair portion 14, from passing thorough the wing-pair portion 14 to the back-surface side of the wing-pair portion 14, enabling sounds to be efficiently emitted frontward from the entire longitudinal split tubular surfaces 12 of the wing-pair portion 14.

In the present embodiment, an outer circumferential portion of the diaphragm 1 is constituted by the cone portion 11 having the circular conical surface shape, enabling the edge member 4 to have the simple round ring shape. Furthermore, the voice coil 20 of the actuator 2 also has the cylindrical shape, and the upper end portion of the voice coil 20 is fixed to both of the cone portion 11 and the wing-pair portion 14 of the diaphragm 1. Thus, an actuator used for typical dynamic speakers can be used as the actuator 2. Accordingly, components used for dynamic speakers constituted by only a normal conical diaphragm can be also used for the edge member 4, the support frame 3, the actuator 2, and other components, resulting in reduced manufacturing cost.

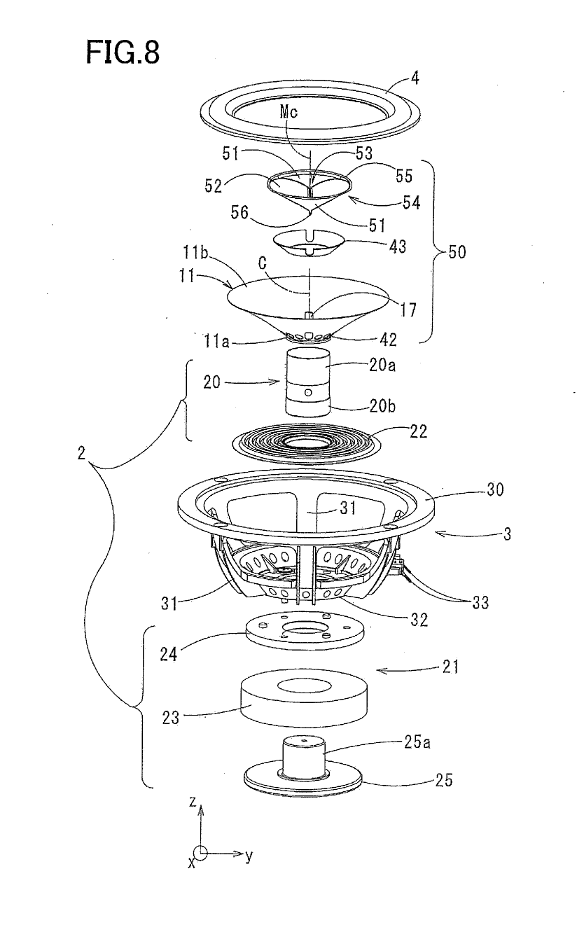

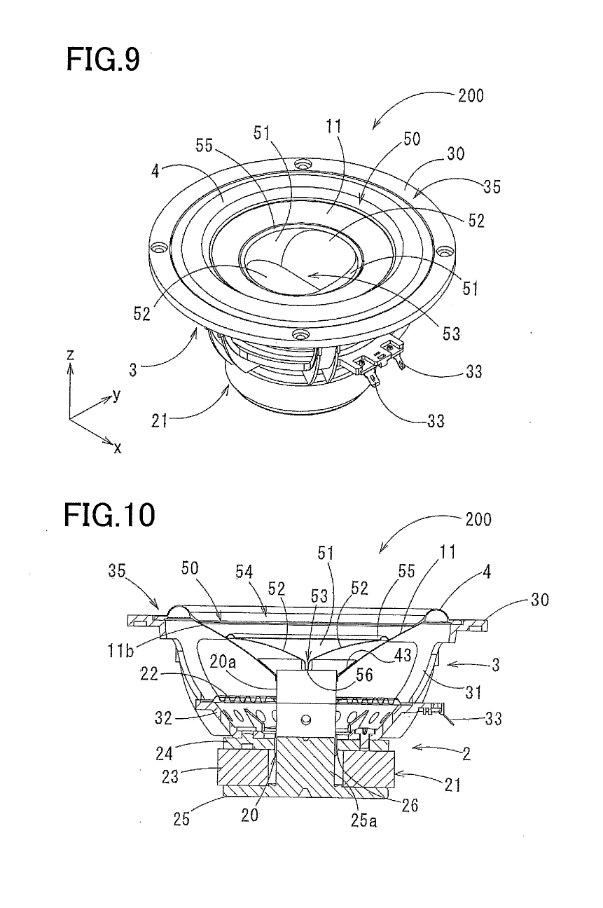

In the above-described first embodiment, as illustrated in FIG. 3, the diaphragm 1 is constituted by the combination of the cone portion 11 and the wing-pair portion 14 having the rectangular shape in front elevational view, but the wing-pair portion having another shape may be combined with the cone portion 11. For example, a wing-pair portion 54 of a diaphragm 50 may have a round shape in front elevational view as in a speaker 200 (an electroacoustic transducer) according to a second embodiment illustrated in FIGS. 8-10. It is noted that the same reference numerals as used in the speaker 100 according to the first embodiment are used to designate the corresponding elements of the speaker 200 according to the second embodiment illustrated in FIGS. 8-10, and an explanation of which is simplified (this also applies the third embodiment).

In the speaker 200 according to the second embodiment, as illustrated in FIGS. 8-10, the wing-pair portion 54 includes a pair of longitudinal split tubular surfaces 52 arranged next to each other. A valley 53 is formed between adjacent side portions of the respective longitudinal split tubular surfaces 52. A valley closer 51 closes opposite end portions of the valley 53 in a direction in which the valley extends. This valley closer 51 has a circular conical surface shape in its entirety and extends from an outer side of the longitudinal split tubular surfaces 52. That is, as illustrated in the cross-sectional view in FIG. 10, assuming that the valley 53 is located on a lower side, a large portion of a surface of the wing-pair portion 54 above the valley 53 is constituted by the longitudinal split tubular surfaces 52, and a portion of the circular conical surface is constituted by the valley closer 51 at opposite ends of the valley 53. A lower end of the wing-pair portion 54 is formed in a straight line by a bottom portion 56 of the valley 53, but an upper end of the wing-pair portion 54 has a round shape in front elevational view.

The construction of the speaker 200 according to the second embodiment other than the wing-pair portion 54 is the same as that of the speaker according to the first embodiment. The diaphragm 50 is constructed such that the wing-pair portion 54 is disposed on the small-diameter-side end portion 11a of the cone portion 11 having the circular conical surface shape, such that the valley 53 points downward. The wing-pair portion 54 is fixed in a state in which the central axis Mc (the central axis of the wing-pair portion 54 which coincides with the central axis of the valley closer 51 having the circular conical surface shape) coincides with the central axis C of the cone portion 11. Accordingly, the bottom portion 56 of the valley 53 of the wing-pair portion 54 is disposed along the radial direction of the small-diameter-side end portion 11a of the cone portion 11 at a lower end portion of the diaphragm 50.

The small-diameter-side end portion 11a of the cone portion 11 has the cutouts 17 for respectively holding opposite end portions of the bottom portion 56 of the wing-pair portion 54. The opposite end portions of the bottom portion 56 of the wing-pair portion 54 are fitted in the respective cutouts 17, and in this state the bottom portion 56 is fixed to the small-diameter-side end portion 11a of the cone portion 11 with an adhesive, for example. The upper end of the voice coil 20 and a lower end of the diaphragm 50 are fixed to each other with an adhesive, for example. In this state, as illustrated in FIG. 10, the upper end portion of the voice coil 20 is inserted from the small-diameter-side end portion 11a of the cone portion 11, and an inserted end of the upper end portion of the voice coil 20 is in contact with the bottom portion 56 of the valley 53 of the wing-pair portion 54. As a result, both of the small-diameter-side end portion 11a of the cone portion 11 and the bottom portion 56 of the valley 53 of the wing-pair portion 54 are fixed to the upper end portion of the voice coil 20. It is noted that the opposite end portions of the bottom portion 56 which are fitted in the respective cutouts 17 are closed by the valley closer 51, thereby preventing sound waves from passing between a front-surface side and a back-surface side of the cone portion 11.

The upper end of the wing-pair portion 54 is connected to the circular conical surface of the cone portion 11 other than its upper and lower ends, with a support member 55 interposed therebetween which is a thin film having a round ring shape. This support member 55 is provided so as to close a space formed between the upper end of the wing-pair portion 54 and the cone portion 11 and supports the wing-pair portion 54 reciprocably. The support member 55 defines the space so as to prevent sound waves radiated from the wing-pair portion 54 from passing to a back-surface side thereof. As in the first embodiment, the support member 55 is formed of a soft material used for typical dynamic speakers, like the edge member 4, so as to prevent hindrance to vibrations of the cone portion 11 and the wing-pair portion 54.

In the speaker 200 according to the second embodiment, as in the speaker 100 according to the first embodiment, the openings 42 are formed in the small-diameter-side end portion 11a of the cone portion 11 to provide the low-pass filter mechanism between the actuator 2 and the cone portion 11. The damper 43 as a thin film is attached to the cone portion 11 so as to close the openings 42. The construction of the openings 42 and the damper 43 adjusts the frequency characteristics of the mechanical low-pass filter.

In the speaker 200 according to the second embodiment constructed as described above, as in the speaker 100 according to the first embodiment, the diaphragm 50 is constituted by the combination of the wing-pair portion 54 and the cone portion 11. Reproduced sounds are radiated from the longitudinal split tubular surfaces 52 of the wing-pair portion 54 and have a wide directivity at middle and high frequencies like the diaphragms used for the riffell speakers. The cone portion 11 reproduces sounds using piston motion of its conical front surface, and accordingly the cone portion 11 has a wide directivity at low frequencies. This construction of the speaker 200 enables a single speaker unit to function as a full-range speaker unit capable of reproducing sounds having wide directivity over the full range of audible frequencies including low frequencies and middle and high frequencies.

In this second embodiment, the opposite end portions of the valley 53 of the wing-pair portion 54 are closed by the valley closer 51 in advance. Thus, when the opposite end portions of the bottom portion 56 of the valley 53 are fitted in the respective cutouts 17 formed in the cone portion 11, the valley 53 is not open to a back-surface side of the cone portion 11. This state prevents sound waves from passing between a front-surface side and the back-surface side of the cone portion 11, enabling efficient radiation of sound waves from the entire front surface of the wing-pair portion 54. Furthermore, the opposite end portions of the valley 13 are closed by the valley closer 51 in the wing-pair portion 54, and the upper end, i.e., an outer circumferential portion of the wing-pair portion 54 has a round shape in front elevational view, enabling the support member 55 to have the simple round ring shape. Accordingly, components used for dynamic speakers constituted by only a normal conical diaphragm can be also used for the support member 55 in addition to the edge member 4, the support frame 3, the actuator 2, and other components, resulting in reduced manufacturing cost.

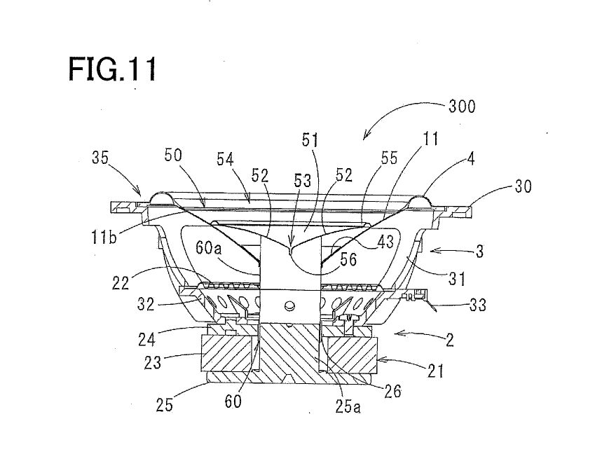

In the speaker 200 according to the second embodiment, as illustrated in FIG. 10, the bottom portion 56 of the wing-pair portion 54 is fixed at its two positions contacting the upper end of the voice coil 20, i.e., the upper end of the cylindrical bobbin 20a, but the wing-pair portion 54 and the voice coil 20 may be fixed to each other at a position or positions different from the above-described positions. One example of this modification is a speaker 300 according to a third embodiment illustrated in FIG. 11. In this speaker 300, a bobbin 60a of a voice coil 60 extends to back surfaces of the respective longitudinal split tubular surfaces 52 and are fixed to not only the bottom portion 56 of the wing-pair portion 14 but also to the back surfaces of the respective longitudinal split tubular surfaces 52 with an adhesive, for example. With this construction, the wing-pair portion 54 and the voice coil 20 are firmly connected to each other with large area and high durability, resulting in smaller loss of transmission of vibration between the wing-pair portion 54 and the voice coil 20, enabling reliable transmission of vibration between the wing-pair portion 54 and the voice coil 20. It is noted that the construction of the wing-pair portion 54 in the third embodiment is the same as that of the wing-pair portion 54 in the second embodiment. The bottom portion 56 is fixed to the bobbin 60a, and the back surfaces of the respective longitudinal split tubular surfaces 52 is fixed to the bobbin 60a in the speaker 200 according to the third embodiment. As a modification of this embodiment, the speaker 200 may be constructed such that the bottom portion 56 is not fixed to the bobbin 60a, and the back surfaces of the respective longitudinal split tubular surfaces 52 are fixed to the bobbin 60a.

While the embodiments have been described above, it is to be understood that the disclosure is not limited to the details of the illustrated embodiments, but may be embodied with various changes and modifications, which may occur to those skilled in the art, without departing from the spirit and scope of the disclosure.

For example, while the cone portion 11 has the circular conical surface shape, and the edge member 4 has the round ring shape in the above-described embodiments, the cone portion and the edge member may have an oval conical surface shape and an oval ring shape, respectively. The cone portion 11 may have a shape different from the circular conical surface shape and the oval conical surface shape as long as the cone portion 11 serves as a diaphragm used for typical dynamic speakers. For example, the cone portion 11 may have a circular shape or a polygonal shape in front view, or a shape formed by combining a circular shape with a polygonal shape. That is, the cone portion 11 may have any shape as long as the cone portion is conical as a whole.

While each of the wing-pair portions 14, 54 is constituted by a single film in the above-described embodiments, each of the wing-pair portions 14, 54 may be constituted by bonding one side portions of two films to each other, for example. Reinforcements such as ribs and blocks may be fixed to a back surface of the wing-pair portion. Ribs each shaped like a plate or a rod may be fixed to the longitudinal split tubular surfaces as the front surface of the wing-pair portion along the circumferential direction. In this speaker, as described above, the longitudinal split tubular surfaces serve as radiation surfaces from which reproduced sounds are radiated. Thus, the directivity is wide along the circumferential direction of each of the longitudinal split tubular surfaces but narrow in a direction perpendicular to the circumferential direction. Accordingly, little audible effects are produced by the ribs each shaped like a plate or a rod provided on the radiation surfaces of the longitudinal split tubular surfaces along the circumferential direction.

While the wing-pair portion includes the pair of longitudinal split tubular surfaces in the above-described embodiments, a plural pairs of longitudinal split tubular surfaces each as the pair of longitudinal split tubular surfaces may be combined with each other, with their respective valleys intersecting each other.

In the above-described embodiments, the openings 42 are formed in the small-diameter-side end portion 11a of the cone portion 11 to provide the low-pass filter mechanism. Instead of or in addition to this construction, a component that reduces transmission of vibration from the voice coil 20 to the upper portion of the cone portion 11 may be provided between the small-diameter-side end portion 11a of the cone portion 11 and the voice coil 20.

The voice coil motor is used as a converter for moving the diaphragm back and forth, but a piezoelectric element may be used instead of the voice coil motor, for example.

While the present invention is applied to the speaker in the above-described embodiments, the present invention may also be applied to microphones. In the case where the present invention is applied to the speaker, the converter such as the voice coil motor converts the electric signal based on the voice signal into the vibrations of the diaphragm. Also in the case where the present invention is applied to the microphones, the voice coil motor may be used as the converter, for example, and this converter converts, into electric signals, vibration of the diaphragm vibrated by sound waves. In the microphone to which the present invention is applied, the cone portion and the wing-pair portion pick up sounds respectively over the low frequency range and at middle and high frequencies, and the transmission of vibration of the cone portion over the high frequency range is reduced, thereby providing good directivity with reliable sensitivity, whereby the microphone can pick up sounds with a wide directivity over a wide frequency range from low frequencies to high frequencies.

### EXPLANATION OF REFERENCE NUMERALS

1, 50: Diaphragm, 2: Actuator (Converter), 3: Support Frame, 4: Edge Member, 11: Cone Portion, 11a: Small-diameter-side End Portion, 12, 52: Longitudinal Split Tubular Surface, 13, 53: Valley, 14, 54: Wing-pair Portion, 16, 56: Bottom Portion, 17: Cutout, 18: End Plate, 20, 60: Voice Coil, 21: Magnet Mechanism, 22: Damper, 23: Magnet, 24: Outer Yoke, 25: Inner Yoke, 25a: Pole, 26: Magnetic Gap, 30: Flange Portion, 31: Arm Portion, 32: Annular Frame Portion, 33: Terminal, 41: Support Member, 42: Opening, 43: Damper, 44: Groove, 51: Valley Closer, 55: Support Member, 100, 200, 300: Speaker (Electroacoustic Transducer)

1. An electroacoustic transducer, comprising:
a diaphragm comprising a cone portion having a conical shape, and a wing-pair portion comprising a pair of longitudinal split tubular surfaces arranged next to each other, a valley being formed between a side portion of one of the longitudinal split tubular surfaces and a side portion of the other of the longitudinal split tubular surfaces;
a converter that performs conversion between vibration of the diaphragm along an axis of the cone portion and an electric signal corresponding to the vibration; and
a supporter that supports the diaphragm such that the diaphragm is movable in an axial direction of the cone portion,
wherein the small-diameter-side end portion of the cone portion, and a part of a portion of the wing-pair portion which portion defines the valley are secured to the converter.

2. The electroacoustic transducer according to claim 1,
wherein the converter comprises: a magnet mechanism secured to the supporter; and a coil that is vibrated in the axial direction with respect to the magnet mechanism,
wherein the part of the portion of the wing-pair portion which portion defines the valley is a bottom portion that defines a bottom of the valley, and
wherein the bottom portion of the wing-pair portion is secured to the coil.

3. The electroacoustic transducer according to claim 1,
wherein the converter comprises: a magnet mechanism secured to the supporter; and a coil that is vibrated in the axial direction with respect to the magnet mechanism,
wherein the part of the portion of the wing-pair portion which portion defines the valley is the pair of longitudinal split tubular surfaces, and
wherein back surfaces of the pair of longitudinal split tubular surfaces are secured to the coil.

4. The electroacoustic transducer according to claim 3, wherein the back surfaces of the pair of longitudinal split tubular surfaces are secured to one of opposite end portions of the coil in the axial direction, which one is nearer to the wing-pair portion than the other.

5. The electroacoustic transducer according to claim 4,
wherein the converter comprises: a magnet mechanism secured to the supporter; and a coil that is vibrated in the axial direction with respect to the magnet mechanism, and
wherein the small-diameter-side end portion of the cone portion is secured to the coil.

6. The electroacoustic transducer according to claim 2, wherein the small-diameter-side end portion of the cone portion is secured to a peripheral portion of the coil.

7. The electroacoustic transducer according to claim 1, further comprising a low-pass filter mechanism that reduces the vibration transmitted from the converter to the cone portion.

8. The electroacoustic transducer according to claim 7, wherein the low-pass filter mechanism is provided on the cone portion.

9. The electroacoustic transducer according to claim 7, wherein the low-pass filter mechanism is configured by making a modulus of elasticity of the small-diameter-side end portion of the cone portion less than that of the wing-pair portion.

10. The electroacoustic transducer according to claim 1, wherein an opening is formed in the small-diameter-side end portion of the cone portion.

11. The electroacoustic transducer according to claim 10, wherein a damper that damps vibration of the small-diameter-side end portion is provided for the opening.

12. The electroacoustic transducer according to claim 11,
wherein a plurality of openings are formed each as the opening, and
wherein the bottom portion of the wing-pair portion is inserted in two openings of the plurality of openings.

13. The electroacoustic transducer according to claim 12, wherein the damper is provided for at least one opening of the plurality of openings which is different from the two openings.
